(19) United States
(12) Patent Application Publication
(10) Pub. No.: US 2017/0021582 A1
(43) Pub. Date: Jan. 26, 2017

(54) AN IMPROVED APPARATUS FOR COMPACTING AND DEHYDRATING ORGANIC WASTE AND/OR ALIMENTARY WASTE

(71) Applicant: TECHO S.R.L., Ferentino, FR (IT)

(72) Inventors: Stefano Ceccarelli, Rieti (IT); Lucio Iacobucci, Frosinone (IT)

(21) Appl. No.: 15/102,423

(22) PCT Filed: Dec. 13, 2013
(86) PCT No.: PCT/IT2013/000350

§ 371 Date: Jun. 7, 2016

(51) Int. Cl. B30B 9/12; B30B 15/34; B09B 3/00; F26B 9/08; C02F 11/12; E03C 1/266; B30B 15/00

(52) U.S. Cl. CPC B30B 9/125; E03C 1/2665; B30B 9/121; B30B 15/34; B30B 15/0094; F26B 9/082; C02F 11/121; B09B 3/0025; F26B 2200/04; C02F 2103/32

(57) ABSTRACT

An improved apparatus for compacting and dehydrating organic waste and/or alimentary waste, comprises: an opening for loading/introducing the organic material and/or the alimentary waste into the apparatus itself; mechanical means for compacting and dehydrating the organic material and/or alimentary waste, comprising a central compacting body, designed to separate the material to be treated from the liquid fraction contained therein; means for collecting and discharging the liquid fraction coming from the treated material; and a drawer, set underneath the central compacting body, for collecting the alimentary waste compacted and dehydrated via the central body and the non-compactable waste that may be introduced manually directly into the drawer.

The present invention relates to the sector of electrical household appliances and in particular regards an apparatus designed to compact and dehydrate domestic organic waste and/or alimentary waste, for example to be installed directly underneath the drain column of the kitchen sink.

This does not on the other hand rule out its use in the commercial field.

Currently, there are not known electrical household appliances capable of compacting domestic organic waste and at the same time dehydrating them.

Consequently, the alimentary waste produced in the kitchen is thrown directly into refuse bags.

This entails a series of drawbacks.

A first drawback is represented by the fact that the aforesaid refuse bags are rapidly filled by domestic organic waste and a plurality of refuse bags are consequently generated, which evidently occupy a considerable space.

Consequently, neither operations for collecting the waste nor those for transporting the waste or storing it are facilitated.

Also known, from the international patent application No. WO2005/061134, is an apparatus for treating alimentary kitchen waste that is equipped with means for compacting and dehydrating waste, but this is a very complicated and somewhat cumbersome apparatus.

The main purpose of the present invention is to overcome the above drawbacks and disadvantages of the prior art by providing an electrical household appliance for compacting and dehydrating organic waste that reduces its volume by approximately 80-90% and the liquids present in said waste by more than 60%. All this entails the reduction of the weight and of the volume of the waste, which, once dehydrated, drastically reduces the formation of percolate.

According to the invention, the above and further purposes have been achieved by providing an apparatus that preferably comprises:
a tube for connection of the drain column of the sink to the top part of the body of the machine (electrical household appliance), designed to receive any organic material and/or alimentary waste, such as for example chicken bones, watermelon peel, potatoes, apples, and damp paper serviettes;
a compacting body equipped with mechanical means for the treatment of said alimentary and/or organic waste designed to compact it and dehydrate it by squeezing it in order to separate it from the liquid fraction; and
an underlying drawer, designed to receive said compacted and dehydrated alimentary waste that exits from the compacting body, for example by dropping by gravity, as well as the alimentary and/or organic waste to be thrown directly in said drawer, such as for example lamb, pork, and beef bones.

According to the invention, there are also provided means of a known type designed to collect and convey the liquids that exit from said compacted and dehydrated alimentary waste into the drains. Said means for collecting and conveying the liquid fraction are preferably comprised in the compacting body.

A better understanding of the invention will be obtained from the ensuing detailed description and with reference to the attached drawings, which illustrate a preferred embodiment merely by way of example.

In the drawings:

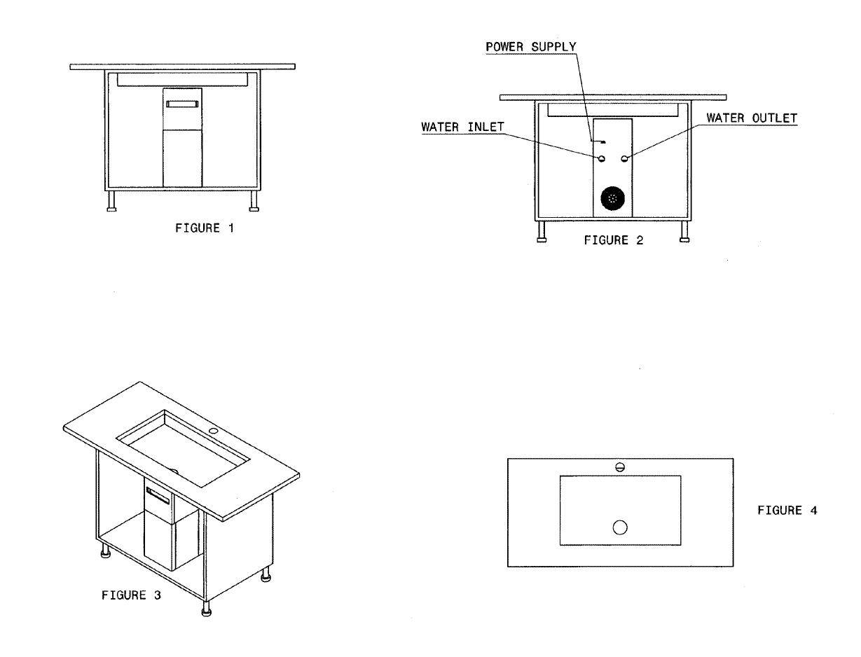

FIGS. 1-4 are schematic illustrations of an example of installation of the apparatus according to the present invention: visible in these figures is the hole of the drain column of the sink, which is located in the direction of the hole for loading the compacting apparatus;

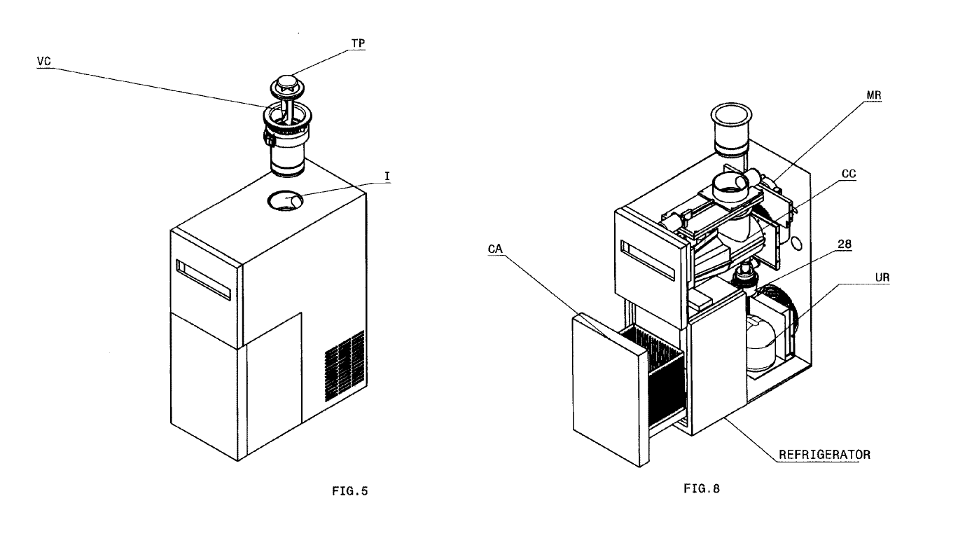

FIG. 5 shows schematically a preferred embodiment of the apparatus for compacting and dehydrating organic waste and/or alimentary waste forming the subject of the invention;

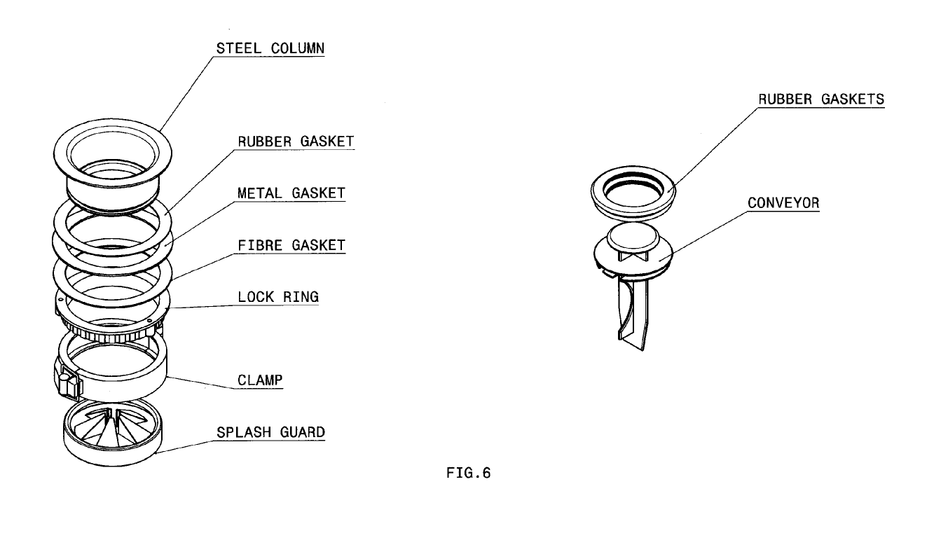

FIG. 6 is an exploded view of the connection valve between the drain of the sink and the inlet duct of the apparatus described;

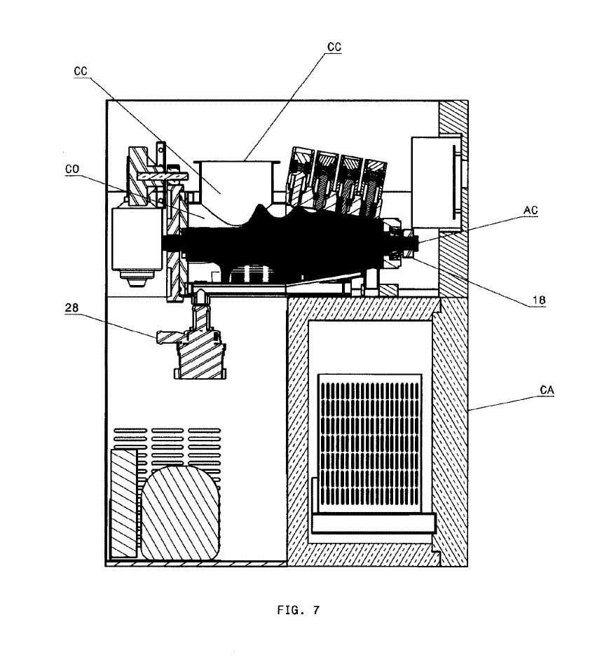

FIG. 7 shows a longitudinal section of the apparatus of FIG. 5, in which the compacted and dehydrated waste falls from the apparatus into the underlying bottom drawer;

FIG. 8, which is similar to FIG. 4, shows the internal parts of the invention, with the bottom drawer open;

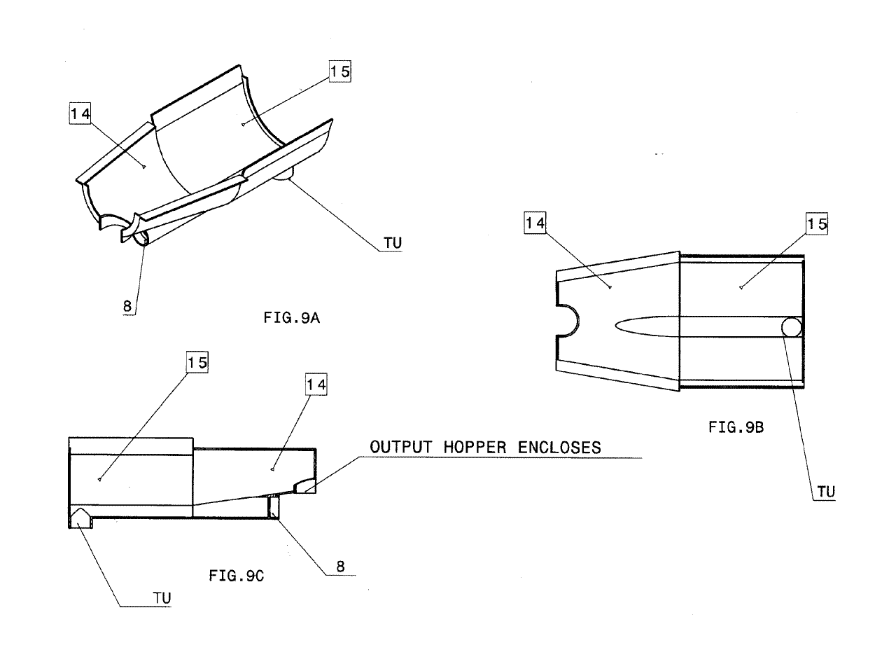

FIGS. 9A, 9B, and 9C are a longitudinal sectional 3D view and a plan view of the tray for collecting liquids;

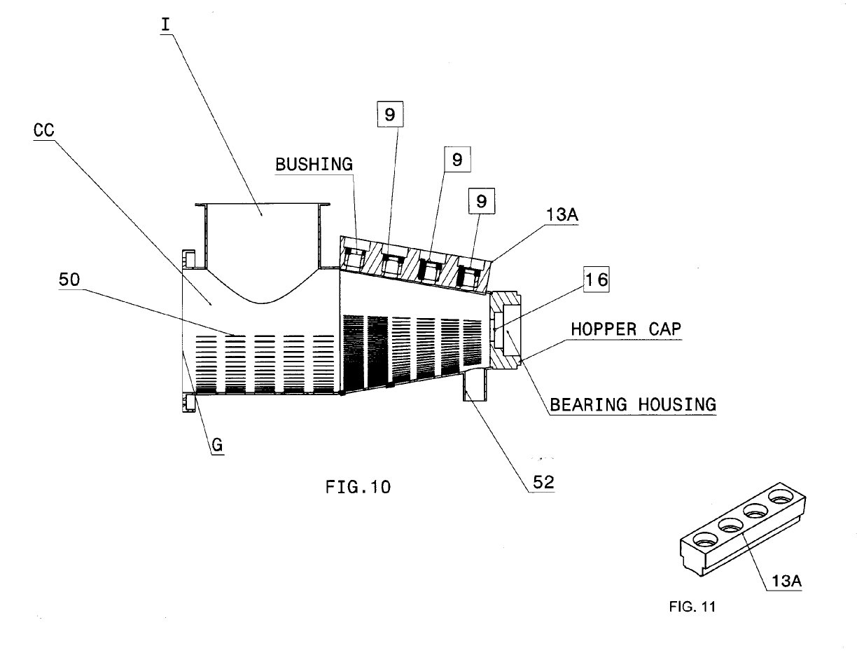

FIG. 10 is a longitudinal section of the central body with the various components fixed to it;

FIG. 11 shows a detail regarding the new support for the guides of the scrapers and/or pistons;

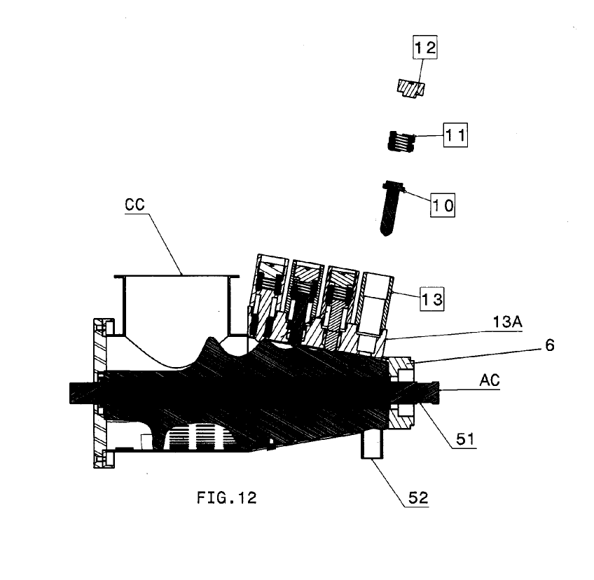

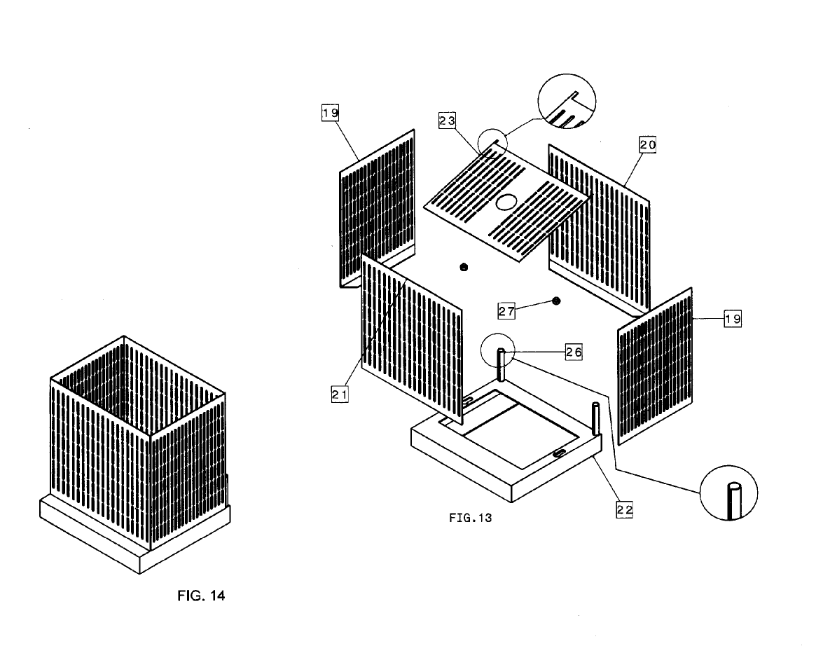

FIG. 12, which is similar to FIG. 10, is a longitudinal cutaway view that shows the auger with its axis and the scrapers mounted on the corresponding support;

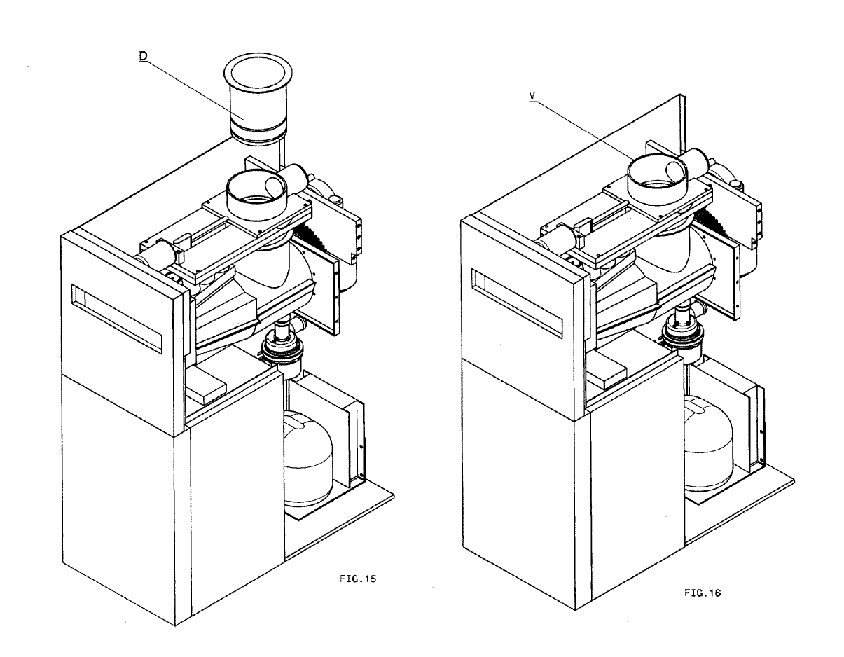

FIGS. 13 and 14 are, respectively, an exploded 3D view and an assembled view of the refrigerating drawer;

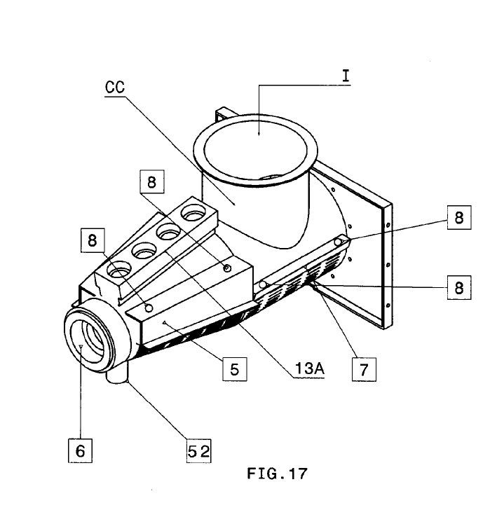

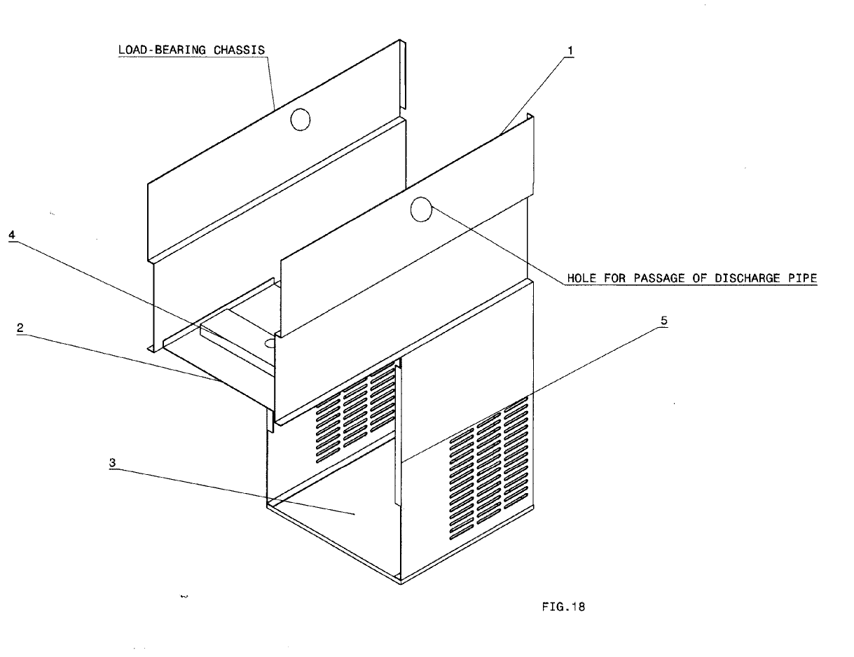

FIGS. 15 and 16, which are substantially similar to FIG. 8, show, respectively, the apparatus according to invention with installed thereon, on the inlet hole, an adjustable spacer for the drain column and a slide valve;

FIG. 17 is a 3D view of the central body alone;

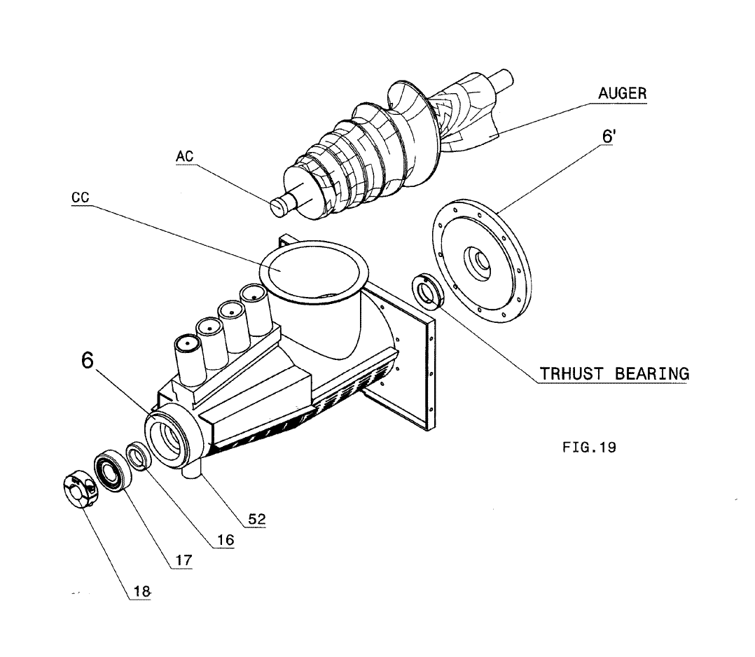

FIG. 18 shows the load-bearing chassis of the apparatus;

FIG. 19, which is similar to FIG. 17, shows some constructional details;

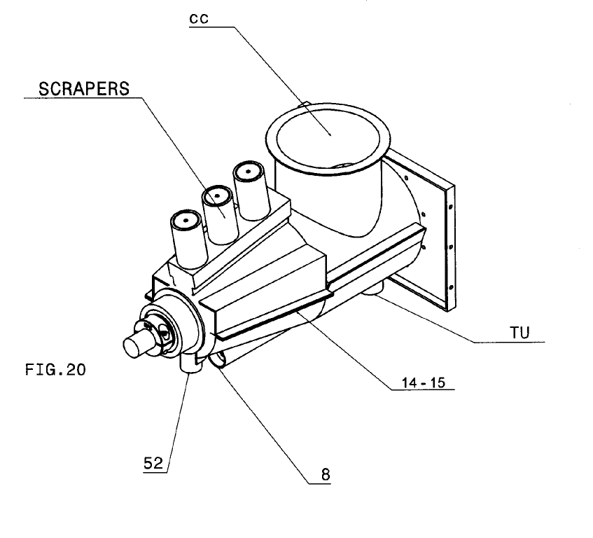

FIG. 20 is a 3D view of the central body alone as a whole, complete with liquid-carrying tray;

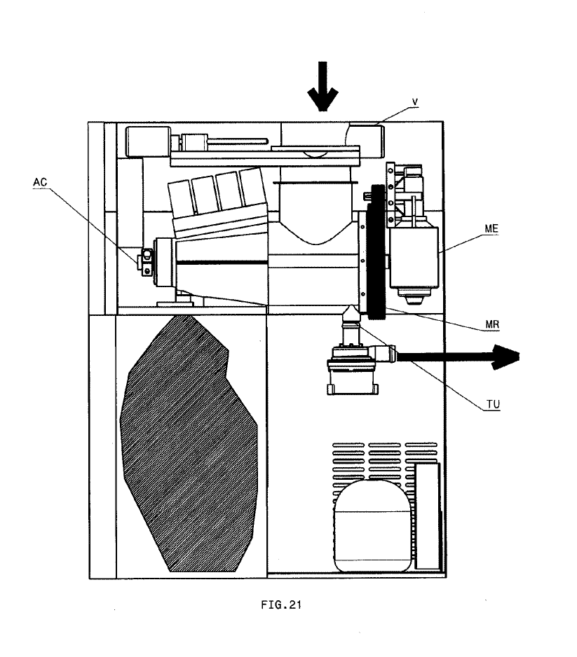

FIG. 21 is a side view of the main internal parts of the apparatus;

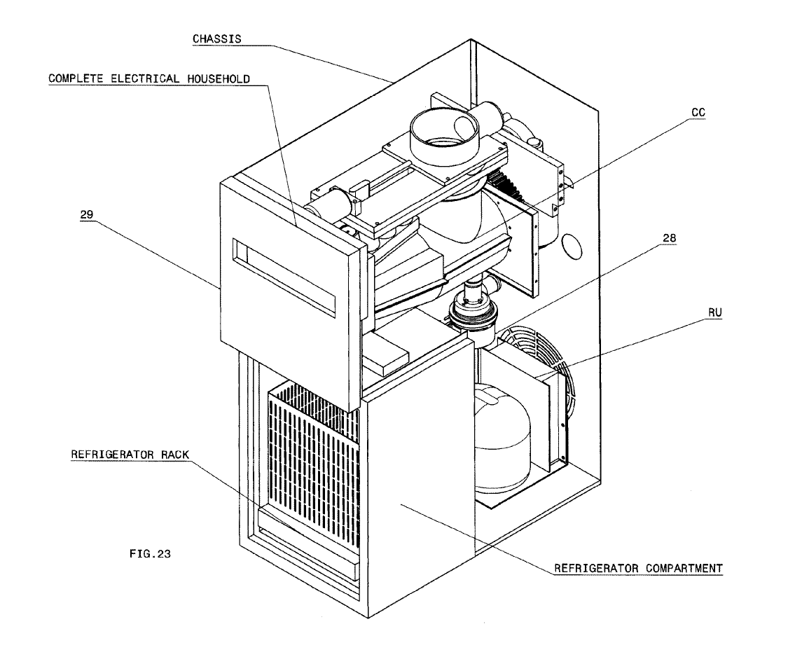

FIGS. 22, 23, and 24 are 3D views that illustrate the internal structural parts of the apparatus;

FIG. 25 is a partially sectioned side view of a variant of the invention that may be used as stand-alone electrical household appliance instead of as under-sink apparatus; it also shows a different arrangement of the motor that drives the auger, on the side opposite to the one for introducing the material to be treated;

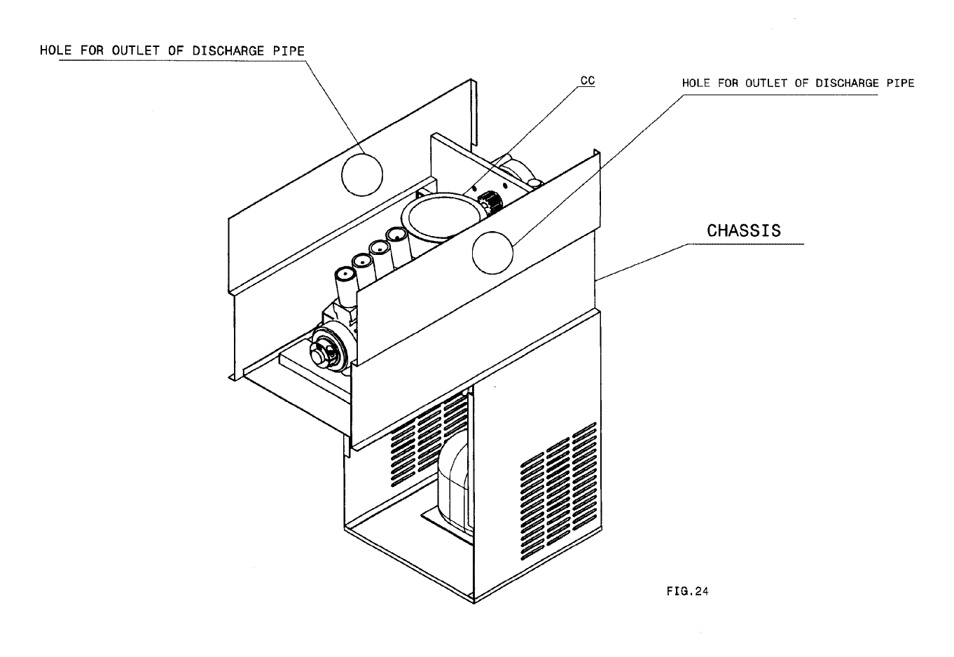

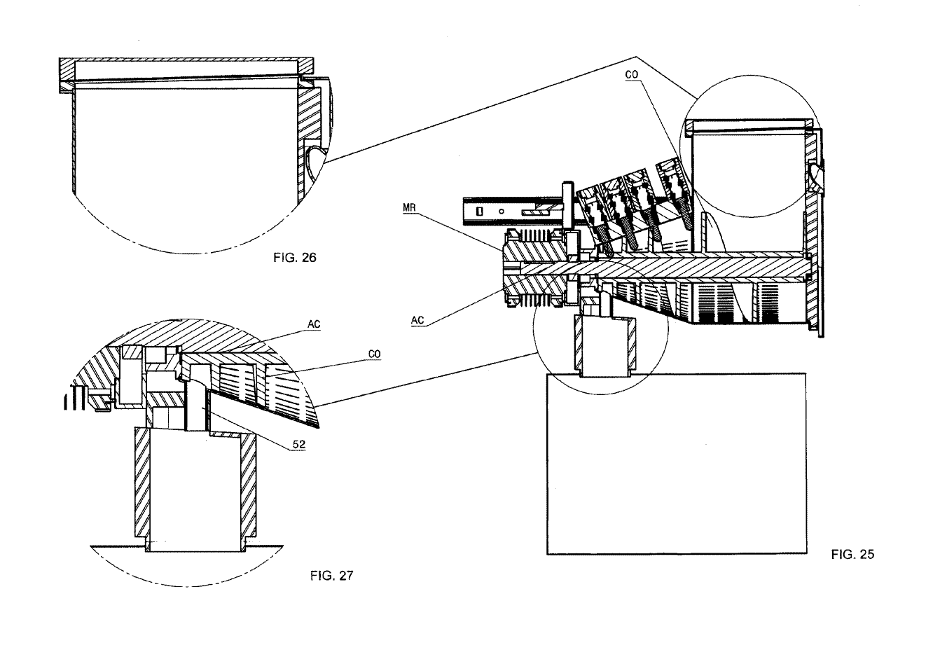

FIGS. 26 and 27 are enlarged details of FIG. 25;

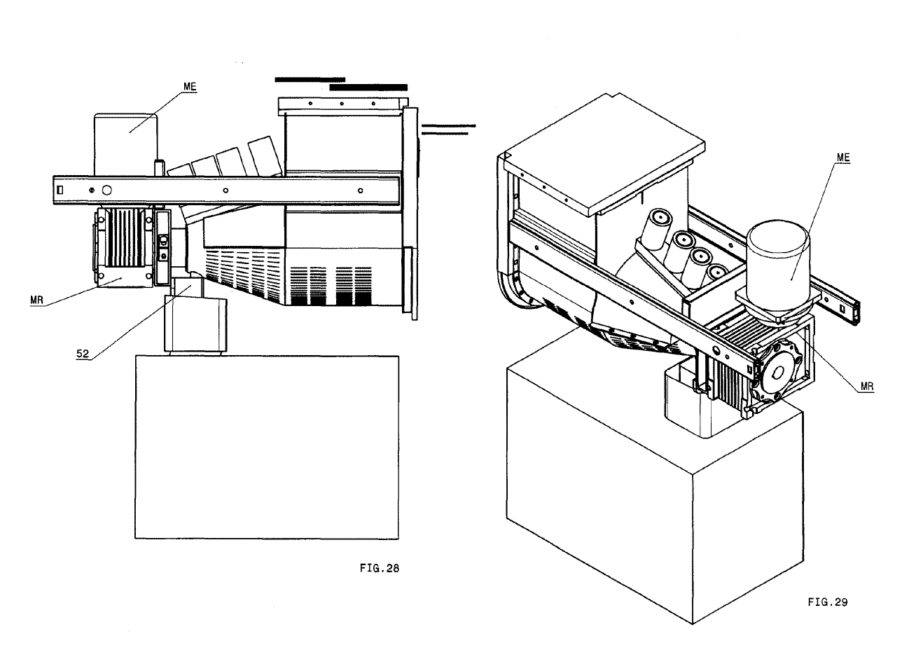

FIGS. 28 and 29 show the side bars, called “guides”, for supporting the central body;

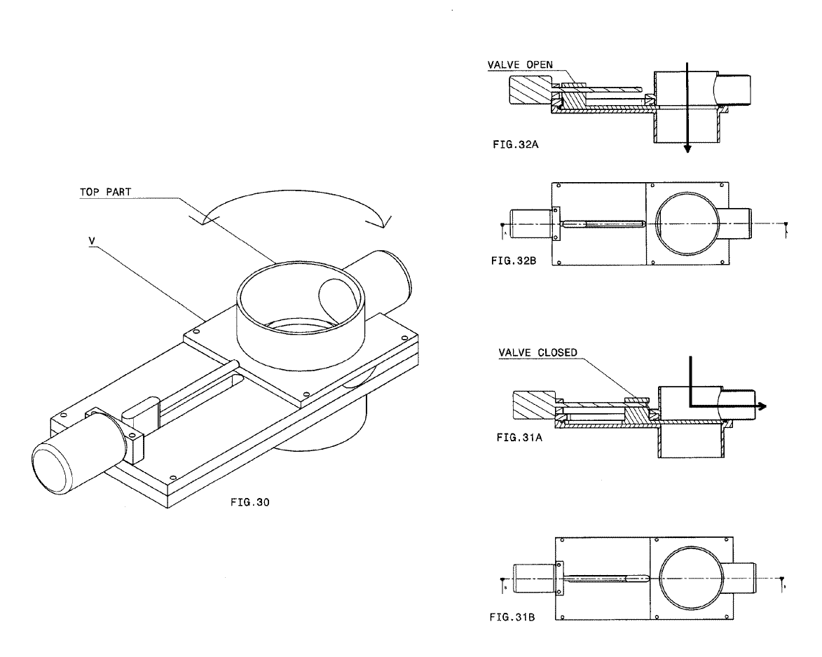

FIG. 30 shows the detail regarding the slide valve on the inlet hole, during installation; this detail can advantageously be rotated through 90° to the right or to the left for directing discharge according to the installation requirements;

FIGS. 31A and 31B show passage of the water with the slide valve in the closed configuration, in order to prevent passage thereof into the apparatus;

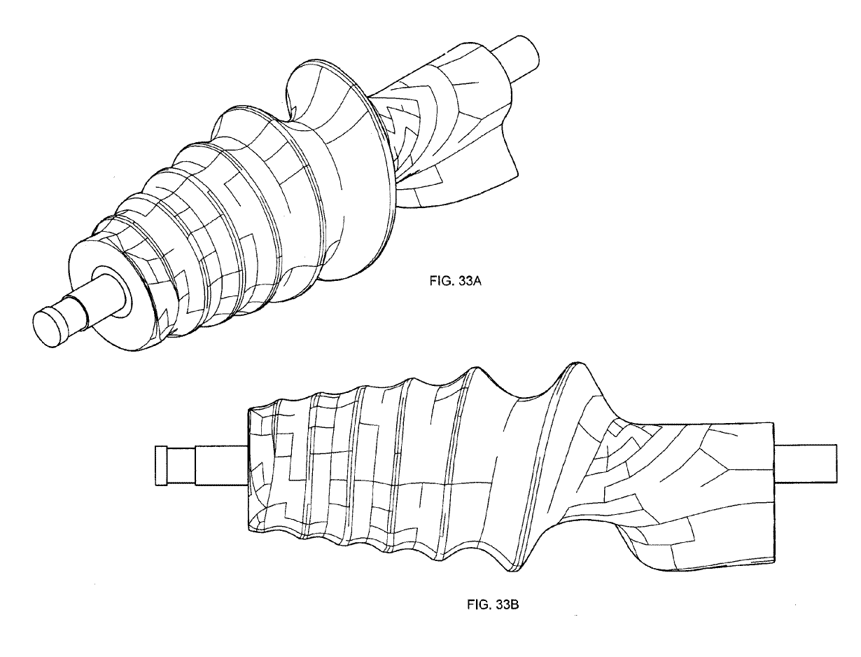

FIGS. 32A and 32B show passage of the organic material and/or alimentary waste with the slide valve open, the waste entering the apparatus for being treated; and

FIGS. 33A and 33B show, respectively, a 3D view and a side view of the auger.

With reference to the figures, provided in the preferred embodiment described is an apparatus for compacting and dehydrating organic waste, comprising:
an opening I (FIG. 5) for loading/introducing the organic material and/or alimentary waste into the apparatus itself;
mechanical means for compacting and dehydrating said organic material and/or alimentary waste, comprising a central compacting body CC, designed to separate the liquid fraction from the material to be treated;
means for collecting and discharging the liquid fraction coming from the treated material;
a drawer CA, underlying the central compacting body CC (FIG. 7), which collects the alimentary waste compacted and dehydrated via said central body CC and possibly the non-compactable waste that can be introduced manually directly into the drawer CA.

In the example described, said mechanical means are basically made up of an auger CO designed to feed and simultaneously compress and dehydrate the organic material introduced by the user into the aforesaid central body CC via the loading opening I connected to the drain of the sink. According to the invention, by compressing and dehydrating said organic material, said auger CO reduces the volume thereof so that the organic liquids contained therein come out via a plurality of self-cleaning slits 50 that are set longitudinally or else like spokes of a wheel in a clockwise direction or counterclockwise direction purposely arranged on the lateral surface of the outer casing of the auger CO (FIG. 10): in this way, a first dehydration of the organic materials and/or alimentary waste is obtained, caused by them being “squeezed”.

The central body CC comprises said means for collecting and discharging the liquid fraction coming from the treated material, and in particular:
means (FIGS. 9A, 9B, and 9C) for collecting, by gravity, said organic liquids, said means being positioned underneath said auger CO;
means for conveying said organic liquids to a pipe for discharge into the drains;
a motor reducer (FIGS. 7 and 8) designed to be connected to the auger CO; and
a hole for loading the material to be treated, located on the top part of the auger CO.

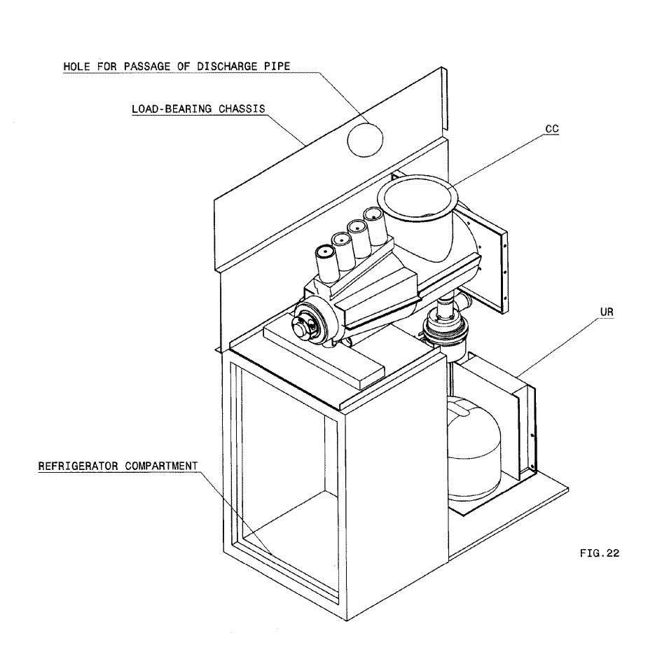

With reference to FIG. 9, said means for collecting the organic liquids are constituted by a jacket defined by at least one collection tray with a frusto-conical front part 14 and a cylindrical rear part 15 (the latter also possibly being made up of two separate parts joined together in a known way), whilst the means for conveying said organic liquids into the drains are constituted by a purposely provided tube TU for outlet of liquids that is designed to be connected to an extraction pump 28 (FIGS. 8 and 23).

In the example illustrated (FIGS. 19 and 33A-33B), the auger CO is a variable-pitch auger and may also be provided with a multi-start screw.

According to a peculiar characteristic of the invention, the auger CO has a shape—from crest to crest—that is markedly concave, as may be seen in FIGS. 33A and 33B, in such a way as to enable the scraper pistons 10 to be accompanied upwards even when said auger CO changes direction of rotation in the event of clogging/jamming.

The auger CO is mounted on an internal shaft AC made of steel and has the external shape of a helix (FIGS. 7 and 33A and 33B), the height of which and the pitch of which decreases starting from the rear end, for entry of the material to be treated, to the front end, for exit of the treated material.

It should be noted that the auger CO is self-cleaning and for this purpose is equipped with one or more scraper pistons 10 housed in a cup-shaped liner 13 pushed towards the auger CO by purposely provided springs 11 blocked by corresponding threaded plugs 12 that are positioned coaxially to the respective springs (FIG. 12). Said threaded plugs 12 are designed also to regulate the pre-loading of the spring.

It should be noted that the cup-shaped liners 13 function as guides for the scraper pistons 10, and for this purpose are firmly anchored on the conical front part of the central body CC, via a purposely provided support 13A.

The aforesaid scraper pistons 10 render the auger self-cleaning because they act directly in the cavities of the auger itself favouring conveying and advance of the material towards the outlet. This in fact enables complete emptying of the loading compartment and cleaning thereof. The upward movement of the pistons 10 is provided by the rotation of the auger CO itself, whereas their downward movement is provided by the return springs 11 housed in the cup 13 itself.

The above auger is housed in a frusto-conical casing (FIG. 10), which, as already mentioned, is equipped with a plurality of self-cleaning slits 50 for enabling the liquids of the “squeezed” organic material to flow into the collection jacket constituted by the collection tray 14, 15 (FIGS. 9A, 9B, and 9C).

The frusto-conical casing illustrated in FIG. 10 has a large rear axial hole G, in which the auger CO is inserted, whilst said top hole I for introducing the material to be treated is set transversely with respect to the rear hole just described, once again in the substantially cylindrical rear part of the central body CC.

According to a preferred embodiment of the invention, the support 13A for the liners 13 for guiding the pistons 10, which is mounted fixedly on the conical front part of the central body CC, is set so that the pistons 10 are perpendicular to the conical surface and not perpendicular to the axis of the auger CO. Alternatively, the pistons 10 could be mounted so as to be perpendicular to the axis of the auger CO.

Another peculiar characteristic of the invention lies in the fact that provided at the free end of the conical front part of the central body CC is a hopper plug 6, which has a seat for an oil seal 16, a seat for a thrust bearing 17, as well as a central hole for passage of the shaft AC of the auger CO.

Advantageously, by gripping radially on the shaft AC of the auger a purposely provided locking element 18 that rests directly on the thrust bearing 17 it is obtained that said shaft AC—which is fixed to the auger CO—can turn freely with respect to the central body and at the same time be blocked axially in a pre-set position so that the auger CO cannot recede during the cycle of squeezing of the organic material to be treated.

The lock ring 18 is fixed on the shaft AC of the auger CO preferably thanks to a groove 51 impressed in the shaft itself of the auger, as may be seen in FIGS. 7 and 12.

Advantageously, in this way the axial thrust generated by the auger CO within the central body CC during treatment of the organic material and/or the alimentary waste discharges directly on the thrust bearing housed in the hopper plug 6 thanks to a locking system 18 (FIG. 19) on the shaft AC of the auger itself. This advantageously enables the possibility of having a lighter and less cumbersome rear structure.

For cleaning the apparatus, a flushing cycle is envisaged, which is carried out in part during the squeezing cycle and completed at the end of the cycle.

Partial flushing is carried out in order to improve the squeezing cycle and for cleaning the tray for collecting liquids 14 and 15 (FIGS. 9A, 9B, and 9C) and the slits 50 (FIG. 10). Flushing moreover facilitates exit of the liquids that are formed during squeezing by conveying them towards the rear discharge duct TU.

Present under the tray, connected downstream of the rear discharge duct TU, is an electric pump 28 that pushes the liquids into the drains.

Also envisaged is the possibility of carrying out one or more supplementary flushing cycles governed manually at the discretion of the user.

For this purpose, one or more spray nozzles 8 is provided (FIG. 17), positioned in strategic points of the apparatus.

Operation of the nozzles is by means of purposely provided timed solenoid valves connected to the water mains or, in the absence of water pressure, by a purposely provided electric pump (not shown).

The drawer CA (FIGS. 7, 8, 13, and 14) is equipped with a structure designed to house a bag for collecting the compacted and dehydrated alimentary waste (compost) that falls by gravity from the front duct 52 of the central body CC.

The drawer CA is made up of a box-shaped load-bearing base 22, screwed to which are the slide guides 25, and of a rack equipped with perforated walls, which may be an enbloc element or else be constituted by two or four composable walls, side walls 19, a rear wall 20, and a front wall 21, to facilitate the cleaning operations.

Also the bottom 23 of the rack can be easily removed for possible cleaning and has two protuberances designed to co-operate with two supporting springs 26, fixed to the load-bearing base 22 of the drawer CA, so that said bottom will be oscillating and slightly inclined.

With the increase of the weight of the dehydrated waste, the above oscillating inclined bottom 23 tends to drop until, once a predetermined end-of-travel position has been reached, there is activation of a sensor that will signal the need to replace the collection bag.

In the proximity of the front end of the auger CO, scraping means are provided, preferably shaped for keeping the auger clean and for facilitating dropping of the compacted and dehydrated alimentary waste into the underlying bag.

In the example described, the aforesaid scraping means comprise at least one knife or scraper piston 10.

In addition, it is preferable for the drawer CA to be equipped with means for drawing in air and conveying it towards the outside.

Said means for drawing in and conveying air towards the outside are positioned in the rear part of the apparatus and comprise a dehumidification fan.

In order to improve ventilation and reduction in weight of the compost, said fan is set on a perforated wall.

It should also be envisaged that the air at outlet from of the apparatus is made to pass through an activated-carbon filter for eliminating any bad smells.

In the preferred embodiment described, the apparatus comprises means for refrigeration of the dehydrated waste designed to be fixed on the load-bearing structure.

With reference to FIG. 8, said refrigeration means comprise, for example, a refrigeration unit UR with an evaporator housed within the compartment that houses the drawer CA.

The drawer CA is designed to be moved along its longitudinal axis for its entire length and may even be totally extractable.

FIG. 15 shows the apparatus according to the invention equipped with a telescopic spacer on the hole I for introducing the material to be treated, where said spacer enables installation of the apparatus to be facilitated, irrespective of the height of the drain hole of the sink with respect to the inlet hole I of the apparatus.

FIG. 16 shows the apparatus according to the invention equipped with a slide valve V on the hole I for introducing the material to be treated. Said slide valve V as per FIGS. 30, 31A, 31B, 32A, 32B, advantageously enables by-passing of the apparatus in the case where the sink has to discharge only water and discharging of the sink into the apparatus only when organic waste and/or alimentary waste has to be discharged, thus avoiding the need for the discharge pump 28 to be activated whenever the sink is to be emptied.

Operation of the slide valve V may be electrical or manual.

As is illustrated clearly in FIGS. 30, 31A, 31B, 32A, 32B referred to above, the valve V has a lateral discharge outlet above the sliding portion of the valve, which has the purpose of enabling direct off-flow of the liquids directly from the discharge hole of the sink into the drains.

The apparatus comprises a mechanism for detecting jamming of the auger based upon the measurement of current absorption, said mechanism being associated to the motor reducer in order to detect rotation thereof.

When the auger gets jammed, current absorption in turn changes considerably and consequently, thanks to a purposely provided electronic card, which controls the entire apparatus, supply of the motor reducer is interrupted. It is possible to unjam said auger automatically via the electronic control card, which, having detected jamming of the auger, acts on the rotation of the motor reducer by reversing the direction of rotation itself for a pre-set time, after which it interrupts supply to the motor reducer itself to enable technical intervention to solve the problem.

According to the invention, the apparatus is also equipped with a light and/or acoustic warning device designed to warn the user that the auger is jammed and that it is necessary to remove the object that has caused jamming of the auger itself.

Said light and/or acoustic warning system is activated by the electronic control card.

The means designed to drive the apparatus described comprise an electrical system, as well as pushbuttons, warning lights, and acoustic warning devices, which are preferably set on the outer front wall of the electrical household appliance:
a main ON/OFF switch;
a switch for start of the compacting and dehydrating cycle;
a switch for start of the supplementary flushing cycle;
green/red warning light of the refrigerating unit;
service warning light;
“drawer full” warning light.

It should be noted that, as an alternative to the ON/OFF switch and to the service warning light, it is possible to provide an ON/OFF switch with the service warning light integrated therein.

In the example described, said pushbuttons and/or switches and/or warning lights and/or warning devices are located on a control panel on the front wall of the apparatus, but said control panel may be positioned also at a distance so as to enable convenient activation of the apparatus without having to open the door of the kitchen-sink cabinet.

A variant of the invention, illustrated in FIGS. 25 to 29, may be used as stand-alone electrical household appliance, which does not need to be installed under the sink where the drain pipe is present, but is installed separately and for this purpose is equipped with a fixed lid that covers the opening I when the apparatus is in the closed configuration for use. In this variant, the apparatus is opened (i.e., displaced along the lateral guides of the load-bearing chassis) only for introducing the organic material and/or the alimentary waste to be treated. Illustrated in the figures just referred to is a different position of the motor reducer MR that moves the auger CO, which is located on the front side of the auger, i.e., the one opposite to that for inlet of the material to be treated. According to the invention, the position of the motor reducer MR and of the corresponding motor ME may indifferently be the one just described or else the one on the opposite side of the auger, as in the foregoing figures regarding the version positioned under the sink.

The present invention has been described and illustrated according to a preferred embodiment and a variant, but it is understood that equivalent modifications and/or replacements may be made by any person skilled in the branch, without thereby departing from the sphere of protection of the present industrial patent right.

1. An improved apparatus for compacting and dehydrating organic waste and/or alimentary waste, characterized in that it comprises, in combination:
an opening (I) for loading/introducing the organic material and/or the alimentary waste into the apparatus itself;
mechanical means for compacting and dehydrating said organic material and/or alimentary waste, comprising a central compacting body (CC), designed to separate the material to be treated from the liquid fraction contained therein;
means for collecting and discharging the liquid fraction coming from the treated material; and
a drawer (CA), set underneath said central compacting body (CC), for collecting the alimentary waste compacted and dehydrated via said central body (CC) and the non-compactable waste that can be introduced manually directly into said drawer (CA),
wherein said mechanical means for compacting and dehydrating said organic material and/or alimentary waste are basically made up of an auger (CO) designed to feed and simultaneously compress and dehydrate the organic material introduced by the user into said central body (CC) via the loading opening (I);
and wherein said auger (CO) compress and dehydrate said organic material reducing the volume thereof so that the organic liquids contained therein come out via a plurality of self-cleaning slits (50) that are set longitudinally or else like spokes of a wheel in a clockwise direction or counterclockwise direction purposely provided on the lateral surface of the outer casing of the auger (CO).

2. The apparatus according to claim 1, characterized in that said means for collecting and discharging the liquid fraction coming from the treated material are comprised in the central body (CC) and include, in combination:
means (14-15) for collecting, by gravity, said organic liquids, said means being positioned underneath said auger (CO);
means (TU) for conveying said organic liquids to a pipe for discharge into the drains;
a motor reducer (MR) designed to be connected to the auger (CO); and
a hole for loading the material to be treated located on the top part of the auger (CO).

3. The apparatus according to claim 2, characterized in that said means for collecting the organic liquids are constituted by a jacket defined by at least one collection tray with a frusto-conical front part (14) and a cylindrical rear part (15), whilst the means for conveying said organic liquids into the drains are constituted by a purposely provided tube (TU) for outlet of liquids that is designed to be connected to an extraction pump (28).

4. The apparatus according to any one of the preceding claims, characterized in that the auger (CO) is a variable-pitch auger and/or is made with a multi-start screw, or else in that the auger (CO) has a helical outer shape, the height of which and the pitch of which diminish from the rear end, for entry of the material to be treated, to the front end, for exit of the treated material.

5. The apparatus according to any one of Claims to 3, characterized in that the auger (CO) has a shape—from crest to crest—that is very concave in such a way as to enable scraper pistons (10) to be accompanied upwards even when said auger (CO) changes direction of rotation in the event of clogging/jamming.

6. The apparatus according to any one of the preceding claims, characterized in that the auger (CO) is self-cleaning and for this purpose is equipped with one or more scraper pistons (10) housed in a respective cup-shaped liner (13), which are pushed towards the auger (CO) by purposely provided springs (11) blocked by corresponding threaded plugs (12) that are positioned coaxially to the respective springs; said threaded plugs (12) being also designed to adjust the pre-load of the respective spring; wherein the cup-shaped liners (13) function as guide for the scraper pistons (10), and for said purpose are firmly anchored on the conical front part of the central body (CC), via a purposely provided support (13A).

7. The apparatus according to claim 6, characterized in that the movement of rising of the pistons (10) is transferred thereto by the rotation of the auger (CO) itself, whereas the movement of descent is transferred thereto by the return springs (11) housed in the respective cup (13).

8. The apparatus according to claim 1 or claim 2, characterized in that said auger is housed in a frusto-conical casing equipped with a plurality of self-cleaning slits (50) for enabling the liquids of the “squeezed” organic material to flow into the collection jacket constituted by the collection tray (14-15), wherein said frusto-conical casing has a large axial rear hole (G), in which the auger (CO) is inserted, whilst said top hole (I) for introducing the material to be treated is set perpendicular to the said rear hole, once again in the substantially cylindrical rear part of the central body (CC).

9. The apparatus according to claim 6, characterized in that the support (13A) for the liners (13) for guiding the pistons (10), which is mounted fixedly on the conical front part of the central body (CC), is set so that the pistons (10) are perpendicular to the conical surface and not perpendicular to the axis of the auger (CO), or else said support (13A) is set so that the pistons (10) are perpendicular to the axis of the auger (CO).

10. The apparatus according to any one of the preceding claims, characterized in that at the free end of the front part of the central body (CC) is a hopper plug (6), which has a seat for an oil seal (16), a seat for a thrust bearing (17), as well as a central hole for passage of a shaft (AC) of the auger (CO); thus obtaining that, by gripping radially on the shaft (AC) of the auger a purposely provided locking element (18) that rests directly on the thrust bearing (17), said shaft (AC)—which is fixed to the auger (CO)—can turn freely with respect to the central body (CC) and at the same time is blocked axially in a pre-set position, so that the auger (CO) cannot recede during the cycle of squeezing of the organic material to be treated; wherein the locking element (18) is fixed on the shaft (AC) of the auger (CO) by means of an annular groove (51) provided in the shaft itself of the auger; thus obtaining that the axial thrust generated by the auger (CO) within the central body (CC) during treatment of the organic material and/or the alimentary waste is discharged directly on the thrust bearing housed in the hopper plug (6) thanks to said lock ring (18) on the shaft (AC) of the auger itself.

11. The apparatus according to any one of the preceding claims, characterized in that for cleaning the apparatus a flushing cycle is envisaged, which that is carried out in part during the squeezing cycle and completed at the end of the cycle, there being provided for this purpose one or more spray nozzles (8) positioned in different points of the apparatus, which are actuated by purposely provided timed solenoid valves connected to the water mains, or, in the absence of water pressure, by a purposely provided electric pump.

12. The apparatus according to any one of the preceding claims, characterized in that the drawer (CA) is equipped with a structure designed to house a bag for collecting the compacted and dehydrated alimentary waste (compost) that drops by gravity from a front duct (52) of the central body (CC); wherein the drawer (CA) is made up of a box-shaped load-bearing base (22), screwed to which are the slide guides (25) and a rack provided with perforated walls, which may be an enbloc element or else be constituted by two or four composable walls, namely, side walls (19), a rear wall (20), and a front wall (21), to facilitate cleaning operations; wherein the rack has a bottom (23) that can be easily removed for possible cleaning and two protuberances designed to co-operate with two supporting springs (26), fixed to the load-bearing base (22) of the drawer (CA) so that said bottom will be oscillating and slightly inclined; where, with the increase in weight of the dehydrated waste, said oscillating inclined bottom (23) tends to drop until, once a predetermined end-of-travel position has been reached, it activates a sensor that will indicate the need to replace the collection bag.

13. The apparatus according to an one of the preceding claims, characterized in that it comprises means for refrigeration of the treated material, which in turn comprise a refrigeration unit (UR) with an evaporator housed within the compartment that houses the drawer (CA); the latter being designed to be moved along its longitudinal axis for its entire length or being totally extractable.

14. The apparatus according to any one of the preceding claims, characterized in that, in the case where it has to be installed under the drain of the sink, provided on the hole (I) for introducing the material to be treated is a telescopic spacer (D) to facilitate installation of the apparatus, irrespective of the height of the drain hole of the sink with respect to the hole (I) of the apparatus.

15. The apparatus according to claim 14, characterized in that provided on the hole (I) for introducing the material to be treated is a slide valve (V) for by-passing the apparatus in the case where the sink has to discharge only water and for enabling discharge of the sink into the apparatus only when organic waste and/or alimentary waste to be treated has to be discharged; operation of the slide valve (V) being electrical or manual.

16. The apparatus according to claim 2, characterized in that it comprises a mechanism for detecting jamming of the auger (CO) based upon the measurement of the absorption current, said mechanism being associated to the motor reducer (MR) for detecting rotation thereof: when the auger is jammed, current absorption in turn changes considerably and consequently, thanks to a purposely provided electronic card, which controls the entire apparatus, supply of the motor reducer is interrupted; it being possible to unjam said auger (CO) automatically via the electronic control card, which, having detected jamming of the auger, acts on the rotation of the motor reducer by reversing the direction of rotation for a pre-set time, after which it interrupts supply to the motor reducer itself to enable technical intervention for solving the problem; wherein a warning light and/or acoustic warning device is provided, activated by the electronic control card, designed to warn the user that the auger is blocked and that it is necessary to remove the object that has caused jamming of the auger itself.

17. The apparatus according to any one of the preceding claims, characterized in that the means designed to drive the apparatus comprise an electric wiring system, as well as pushbuttons, warning lights, and acoustic warning devices that are set preferably on the outer front wall of the electrical household appliance, among which:
a main ON/OFF switch;
a switch for start of the compacting and dehydrating cycle;
a switch for start of the supplementary flushing cycle;
green/red warning light of the refrigerating unit;
“service” warning light;
“drawer full” warning light.

18. The apparatus according to claim 17, characterized in that said pushbuttons and/or switches and/or warning lights and/or acoustic warning devices are located on a control panel set at a distance so as to enable convenient activation of the apparatus without having to open the door of the kitchen-sink cabinet.

19. The apparatus according to any one of the preceding claims, characterized in that provided on the opening (I) for introducing material is a fixed lid that covers the opening itself when the apparatus is in the closed configuration for use; said apparatus being opened, i.e., displaced along the lateral guides of the load-bearing chassis, only for introducing the organic material and/or the alimentary waste to be treated.
